(19) United States
(12) Patent Application Publication
(10) Pub. No.: US 2019/0373872 A1
(43) Pub. Date: Dec. 12, 2019

(54) Thermochromic Lure

(71) Applicant: Gary Lemaster, Staffordsville, KY (US)

(72) Inventor: Gary Lemaster, Staffordsville, KY (US)

(21) Appl. No.: 16/431,698

(22) Filed: Jun. 4, 2019

Related U.S. Application Data
(60) Provisional application No. 62/680,136, filed on Jun. 4, 2018.

(51) Int. Cl. A01K 85/00

(52) U.S. Cl. CPC A01K 85/00

(57) ABSTRACT

A thermochromic fishing lure is disclosed which adapts its color to the seasonal coloration of the bait it resembles through the use of thermochromic paints applied in layers of decreasing transition temperatures from the lure body outward.

### CROSS-REFERENCE TO RELATED APPLICATIONS

The present application claims priority to U.S. Provisional Patent Application 62/680,136 filed on Jun. 4, 2018 and entitled Thermochromic Lure.

### FIELD OF TECHNOLOGY

The apparatus of the present application relates generally to fishing lures which incorporate thermochromic coatings. More specifically, it relates to thermochromic fishing lures which change color in response to water temperature to mimic seasonal color changes in bait.

### BACKGROUND

Thermochromic paints are used in a wide variety of applications, where it is desirable to obtain a visual cue as to the temperature of a material and for ornamental uses. One application for which thermochromic paints have been used is on fishing lures to obtain color gradients in finishes on lures and to provide more life-like visual aesthetics. However, the prior art does not describe utilizing thermochromic materials applied to lures for the purpose of mimicking physiologic seasonal coloration changes in bait species in response to water temperature.

Fishing bait such as crawdads and bluegill undergo seasonal color changes that correspond to physiological changes that can be correlated to water temperatures. Physical studies of the eyes and retinas of fish show that the majority can obtain a clearly focused image, detect motion, and have good contrast-detection ability. A limited number of experiments have shown that a minimum level of light is necessary before a fish can recognize colors. Another finding is that some fish favor a specific color. Fish that prey on color changing creatures are believed by many scientists to have become accustomed to the color of their prey and use those colors to identify their preferred food source. It is further believed that predatory fish are accustomed to the seasonal change of color of their prey and change their hunting habits accordingly, avoiding prey that fails to match the anticipated color change. Desensitization to the bait due to the lack of color change reduces the effectiveness of the bait and decreases the chance of a strike from a target fish and negatively affecting the fishing experience for the angler.

Crawfish are a common bait species for predator fish. Crayfish are members of the Phylum Arthropoda. Within that Phylum, they belong to the Subclass Crustacea and the Order Decapoda, which also includes many familiar marine creatures, including lobsters, crabs, and shrimp. The 530 species of crayfish recognized worldwide are distributed in three families: Astacidae, Cambaridae, and Parastacidae. The Cambaridae family, with over 400 species, represents the two-thirds of the world's crayfish species; members of this family are found natively in North America and eastern Asia. The lives of crayfish consist of a continuous process of shedding, or molting, their old exoskeleton, and growing and hardening the new exoskeleton. In the days leading up to molting, crayfishes begin to break down the calcium salts in their exoskeleton and store a small amount of them in small whitish dislike structures called gastroliths. These structures will provide the important initial source of calcium used to harden the new exoskeleton. During the molting process, crayfishes are very vulnerable to predation because they are soft and unable to move effectively: they find refuge under rocks, in woody debris, or in burrows.

For example, as with all crustaceans, a crawfish must molt its hard, external shell (“exoskeleton”) to increase in size. The growth process involves periodic molting interspersed with inter-molt periods. The inter-molt phase is the period in which the exoskeleton is fully formed and hardened. Approximately 11 molts are necessary for young crawfish to reach maturity. The color of a crawfish depends largely on its species and those colorations can also be reproduced with the appropriate thermochromic paint. Molting among crawfish occurs in spring/early summer and results in a color change from a brown/orange calcified shell to a purple soft shell more palatable to certain species of fish. The molting period typically takes place when the water temperature is between 59° F. (15° C.) and 64° F. (18° C.). In the landlocked Southeastern United States, Procambarid crawfish are typically brown/orange but turn green when molting in the summer as the water temperature climbs above 64° F. (18° C.). Crawfish can burrow for reproduction at any time of the year but do so most often in late spring/early summer in the South when waters are starting to warm.

The same effect can be found in many species of fish when spawning. Bluegill is a popular species of fish often used as bait. The lower half of the fish is normally a grayish-green. When spawning, the male Bluegill develops orange and yellow patches along its base when the water temperature is around 70° F. (21° C.) to 75° F. (24° C.).

Predatory fish accustomed to the present color of their prey seek lures which match the expected coloration. Prey that does not match the expected color of the species at a given time are likely to be considered inedible due to disease or are otherwise unattractive for consumption. Fishing lures designed to resemble bait, i.e. prey for fish, but which do not correspond to the anticipated color of the prey are therefore less likely to be effective and may even alarm the target fish.

Thermochromic materials can include leuco dyes and liquid crystals. These can be incorporated in coatings to produce the desired effects. Liquid crystals provide precise control at target temperatures but are hindered by limitations in color. Leuco dyes offer a wider range of coloration but are problematic in attempts to achieve a desired result at a specific temperature.

Leuco dyes switch their chemical form based on an external stimulus. They are incorporated in thermochromic dyes which use thermal energy to achieve a reversible color change. Leuco dyes are contained within microcapsules and diluted into appropriate solvents. The precise mechanism employed depends on the chemical structure of the dye and the solvent. For example, in some instances a solid solvent containing an organic or inorganic salt is selected which melts at a known temperature and causes the salt to disassociate and affect the pH within the microcapsule, thus causing a reversible reaction which can shift the wavelengths at which the dye either absorbs or reflects light.

Liquid crystals have properties between those of conventional liquids and those of solid crystals. Liquid crystals have narrow temperature ranges in which they reflect light of a relatively narrow range of wavelengths. As liquid crystals phase shift with a change in temperature, they pass through a nematic mesophase at some point and results in the appropriate spacing of the molecules for the liquid crystal to act similar to a diffraction grating. The spacing interferes with specific wavelengths of light which are then reflected back and do not pass through the liquid crystal. The thermochromic film is initially in its monoclinic state (cold state) at lower temperatures (usually room temperature).

As the temperature exceeds a threshold temperature, the thermochromic material changes its nature from monoclinic to rutile state. This phenomenon is called metal to semiconductor transition (MST). In rutile state (hot state) the thermochromic material acts like a semi-metal, reflecting a wide range of solar radiation. Comparatively, almost all inorganic materials exhibit color change with temperature. Electronic properties of such materials at different temperatures cause this thermochromic effect, although some thermochromic materials exhibit more drastic color and property changes with temperature. The following tables provide some examples of useful thermochromic materials and the effect of some materials on thermochromic coatings.

| | Tₜ | Cold state | Hot state | |
|---|---|---|---|---|
| TC material | (° C.) | color | color | Reason of transition |
| Cuprous mercury iodide | 55 | Bright | Dark | Cu(I)—Hg(II) charge transfer |
| (Cu₂HgI₄) | | red | brown | |
| Silver mercury iodide | 47− | Yellow | Orange | Cu(I)—Hg(II) charge transfer |
| (Ag₂HgI₄) | | | | |
| | 51 | | | |
| Mercury(II) iodide | 126 | Red | Pale | Reversible change transition |
| | | | yellow | |
| Bis (dimethylammonium) | 110 | Raspberry- | Blue | |
| tetrachloronickelate | | red | | |
| Bis (diethylammonium) | 52− | Bright | Yellow | Relaxation of the hydrogen |
| tetrachlorocuprate | | green | | bond an change of arrangement |
| | | | | of the copper atom's d-orbitals d |
| | 53 | | | |
| Nickel sulfate | 155 | Green | Yellow | |
| Chromium(III) oxide: | 400 | Red | Grey | Changes in its crystal field |
| aluminium(III) oxide | | | | |
| (1:9) | | | | |
| chromium-rich pyropes | 80 | | Green | |
| normally reddish-purplish | 80 | | Green | |
| titanium dioxide | | White | Yellow | |
| zinc oxide | | White | Yellow | |
| indium(III) oxide | | Dark | Yellow | |
| | | yellow | brown | |
| Lead(II) oxide | | Dark | Yellow | |
| | | yellow | brown | |

| Material | Effect on MST | Tₜ | | Film color |
|---|---|---|---|---|
| Pure VO₂ crystals | — | 68° | C. | Brown/yellow |
| Un-doped VO₂ films | — | 50-66° | C. | Brown/yellow |
| Tungsten doping | 23% ΔT at 2500 nm | 20° C. 1.56 at % | | Blue |
| | | 25° C. 2.7 mol % | | |
| Gold nanoparticle | 35-40% ΔT and 10% ΔR at 2500 nm | 15-20° | C. | Green/blue |
| | | | | Varies in |
| | | | | different |
| | | | | temperatures |
| Fluorine doping | 15% ΔT and 5% ΔR | 60° | C. | Brown/yellow |
| | | 25° | C. | |
| TiO₂ | 21.2% IR-ΔT and 84% Vis-ΔT | 50-60° | C. | Brown |
| | 5-10% ΔT at 2500 nm | | | |
| CeO₂ | 5-10% ΔT at 2500 nm | 50-60° | C. | Brown/yellow |

A thermochromic paint composition comprises the thermochromic component dispersed in a conventional liquid paint formulation. The term “liquid paint formulation” is meant to describe conventional solvent-binder systems used in preparing paints. Liquid paint formulations typically contain water or an organic solvent having dispersed or dissolved therein a polymeric or resin binder. Typical binders include natural resins such as kauri, copal, shellac, pontianak, dammar, sandarac and the like, and synthetic resins such as alkyd resins, nitrocellulose, phenolic resins, amino resins, polyvinyl acetate, polyvinyl alcohol, polyvinyl butyral, polyvinyl pyrrolidone, copolymers of vinyl acetate and vinyl chloride, methacrylate, polymers of methyl methacrylate and polymers of butyl acrylate, polymers and copolymers of ethylene, propylene, styrene, butadiene and isoprene, and the like.

Solvents which can be used include, but are not limited to turpentine, aromatic hydrocarbons, such as benzene, toluene, and the xylenes, chlorinated hydrocarbons, such as trichloroethane, alcohols, such as ethanol and butanol, ketones, such as acetone, isobutyl ketone, methyl ethyl ketone, esters, such as ethyl acetate, and the like.

### SUMMARY

The present application discloses the use of thermochromic materials on or within fishing lures that resemble bait for predatory fish so as to cause changes to coloration which correspond to seasonal changes in coloration of the bait which the lure resembles. Patterns of coloration and striations 20 may be constructed by choosing the thermochromic material having the desired properties.

Hard baits may receive a plurality of coatings to achieve desired patterns. Soft baits may be coated and/or impregnated with thermochromic materials to achieve the desire result. Mixtures of thermochromic materials within the same layer may be utilized to achieve desired colorations within specific temperature ranges.

The method of making a fishing lure change color to mimic seasonal changes in bait is also disclosed herein.

### BRIEF DESCRIPTION OF THE DRAWINGS

FIG. 1 depicts a side view of an embodiment of a crawfish lure having a brown to orange coloration imparted by thermochromic materials.

FIG. 2 depicts a side view of an embodiment of a molting crawfish lure having a purple coloration imparted by thermochromic materials.

FIG. 3 depicts a side view of an embodiment of a spawning crawfish lure having an olive-green coloration imparted by thermochromic materials.

FIG. 4 depicts a cross-sectional view of the coating layers on a fishing lure.

### DETAILED DESCRIPTION

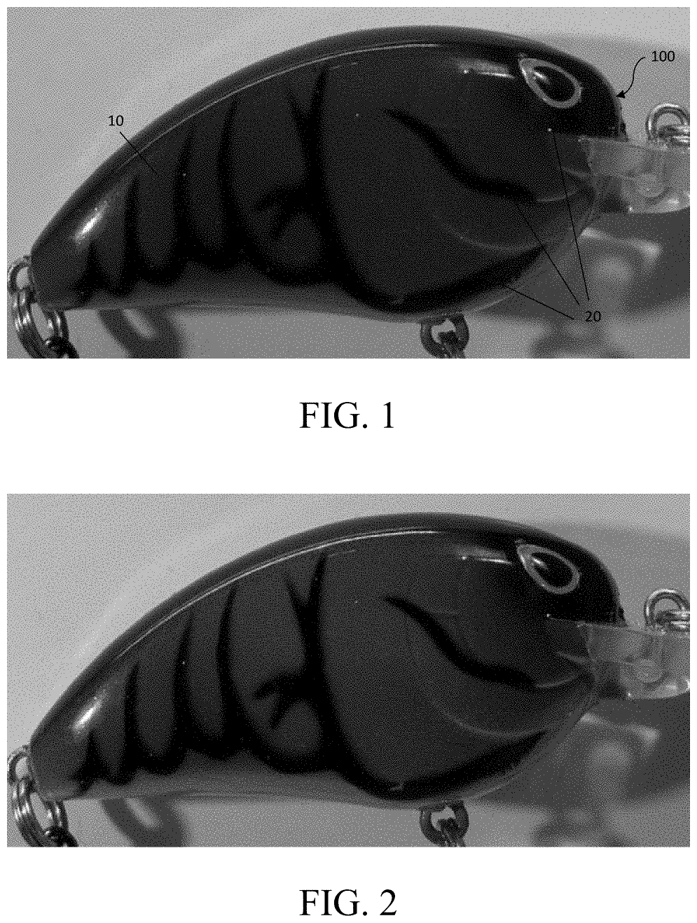

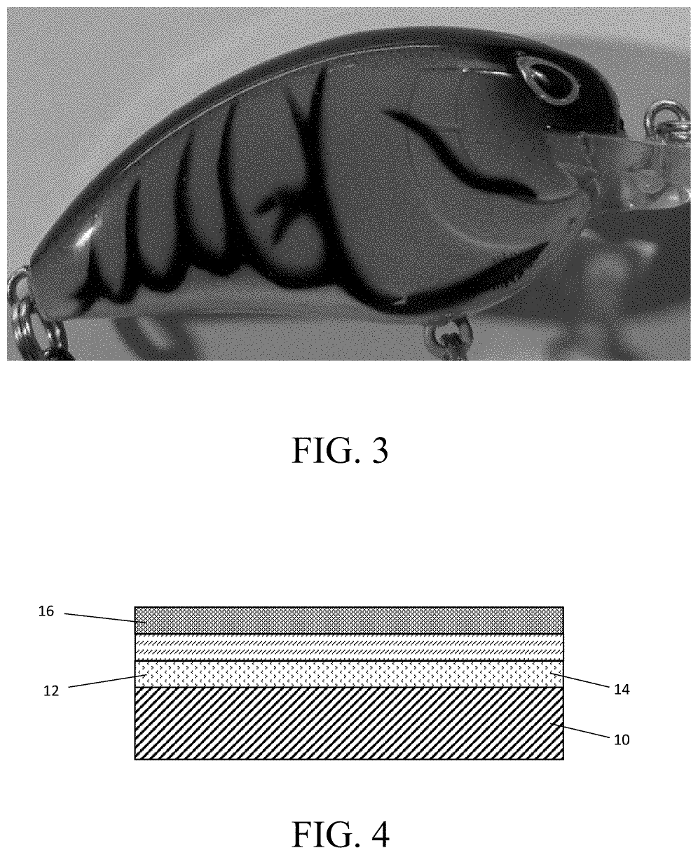

A lure 100, such as a hard bait crawfish lure as depicted in FIGS. 1-3, having a lure body 10 is painted with a base layer of coloration 12 which is displayed when the overlying layers 14, 16 are substantially transparent. Carrier fluids imbued with thermochromic materials, e.g. thermochromic paint, are applied in one or more layers to provide a variety of colorations and/or patterns. The carrier fluid may be a solvent in some embodiments and may be a curable transparent resin or similar material in another embodiment. A curable transparent resin may be applied over each application of thermochromic paint to protect the application of the paint on a surface or applied atop all layers in a single coating. The thermochromic materials are selected based on desired color and transition temperature as well as stability and compatibility with the carrier fluid so as to not affect the thermochromic material's properties and to achieve a fairly homogenous mixture in the carrier fluid prior to and during application. A homogenous mixture permits the user to obtain a fairly consistent color across the surface of the lure onto which it is applied. An exemplary embodiment utilizes a soluble polymer in a solvent, e.g. a water slurry and water-soluble polymer, that cures

Overlapping effective ranges for various thermochromic materials permits the colors to be combined to produce colors not normally found in thermochromic materials within desired temperature ranges. In an embodiment of a crawfish lure, FIGS. 1-3, two coating layers are added to the surface of the lure to achieve three colorations that correspond to the normal color of the crawfish (brown and orange), spawning (olive green), and molting (purple). The physiologic changes that cause the changes in coloration are related to changes in water temperature during different seasons. A combination of time of the year and water temperatures are triggers for the crawfish to undergo the aforementioned physiologic changes. Fish which prey on the crawfish are widely believed to be accustomed to the seasonal color changes and adapt to the changes in color to the point that they can shun crawfish that don't possess the proper coloration for the season as potentially diseased or otherwise unhealthy or unpalatable.

In a useful embodiment for a crawfish lure, the body 10 of the lure is painted an olive green. Crawfish change color during spawning to an olive green and this physiologic transition correlates with warmer waters during the summer months, e.g. water temperatures above 64° F. (18° C.). Thermochromic materials are added to coatings applied to the lure in two layers to provide for a reversible color change. An inner coating layer between the lure and the outer coating applied to the lure utilizes thermochromic material which transitions from a light purple to be substantially transparent at about 64° F. (18° C.). An outer coating layer added atop the inner coating layer utilizes a thermochromic material which transitions from orange to be substantially transparent at about 59° F. (15° C.). At temperatures below 59° F. (15° C.), the thermochromic materials in an embodiment of a crawfish lure in the inner layer and the outer layer are respectively colored orange and purple, resulting in a brown hue. As the temperature rises above 59° F. (15° C.), the orange hue of the outer layer becomes transparent to reveal the purple hue of the inner layer. At a water temperature of approximately 64° F. (18° C.), the purple hue also fades to transparent to reveal the olive-green base color of the lure. Lines may be painted on the lure with a non-thermochromic paint to mimic segmentation of the shell as well as other body parts. Lines painted with thermochromic paint may also be utilized to change the appearance of the bait to a different species altogether.

Similarly, a fishing lure that resembles a bluegill fish has a lower half that normally a grayish-green below about 70° F. (21° C.). When spawning, the male Bluegill develops orange and yellow patches along its base and the grayish-green color along the lower half is replaced by orange and yellow patches at about 70° F. (21° C.) and above when Bluegill are spawning.

The process of making a fishing lure that mimics physiologic color changes requires layering thermochromic materials so that as temperature increases the outer layers of thermochromic materials become sequentially transparent with the rise in temperature, i.e. the outer layer becomes transparent first, followed by the second layer and so on until you reach the base layer. Thermochromic materials can be combined within the same layer to produce a desired color difficult to achieve with such materials. Some layers are somewhat opaque so as to allow the hue of the lower layer to combine with the upper layer to produce a desired color difficult to achieve with such materials, e.g. an orange opaque outer layer over a purple layer to produce a brown hue, so as to allow the top layer to transition so as to be substantially transparent and utilize the inner layer as a coloration for the lure, it's thermochromatic material having a higher transition temperature. As depicted in FIGS. 1-3, an embodiment where the layers of coloration correspond to increasingly higher water temperatures by utilizing sequentially higher transition temperatures as you advance from the outermost layer of thermochromic material to the innermost layer is especially useful to approximate seasonal color changes associated with increasing water temperatures of bait species.

The method of mimicking seasonal coloration changes to the lure to match the anticipated coloration of the prey it resembles during those seasons when physiologic changes induce color changes and can be correlated to anticipated water temperatures is disclosed herein. Appropriate colorations could include matching striations 20 and other color features on the shell of the crawfish. A crawfish lure would necessarily require thermochromic coatings over virtually the entire lure.

A bluegill lure would not require a thermochromic coating over the entire lure, but rather would only require thermochromic materials where coloration changes during spawning need to be simulated. The majority of the bluegill lure retains its normal blue-green coloration and patterns, while the bottom of the lure could incorporate the expected shades of orange, yellow, and white that predatory fish would expect to see during spawning.

Thermochromism can also be incorporated into polymeric materials, e.g. thermoplastics and duroplastics, thus molded baits also can benefit from the use of thermochromic materials. The polymer itself, an embedded thermochromic additive or a high ordered structure built by the interaction of the polymer with an incorporated non-thermochromic additive can be the origin of the thermochromic effect. The thermochromic materials can be included in the resin for the molded bait just as they are in the coating to be applied to the surface of bait.

Additionally, thermochromic films can be directly deposited on different substrates by physical vapor deposition (PVD), sputtering, sol-gel techniques, pulsed laser techniques, and chemical vapor deposition. A plurality of such films could be applied across various areas of a hard bait by appropriate masking methods. Moreover, the application of thermochromic inks could be mechanically applied via commercially available inkjet technologies.

The described embodiments are intended only for exemplary purposes only and are not intended to limit the scope of the device. Alternative embodiments may be obvious to one skilled and the art upon reading this disclosure.

What is claimed is:

1. A fishing lure comprising a plurality of thermochromic materials layered onto a lure body in the order of decreasing transition temperatures with each successive layer outward from said base layer so as to reveal the colored layer beneath each successive outerlayer as temperatures increase and transition temperatures are achieved for each layer of thermochromic material.

2. The fishing lure of claim 1, wherein at least some of said thermochromic materials undergo a reversible color change at their transition temperature.

3. The fishing lure of claim 1, wherein colors and transition temperatures for said plurality of thermochromic materials are chosen and layered so as to cause said lure to resemble prey for fish by applying said plurality of thermochromic materials so that a base layer on said lure body incorporates colorations that cause said lure to resemble said prey at warmer temperatures correlated with physiologic changes to prey coloration and an outerlayer on said body incorporates colorations and features that cause said lure to resemble said prey at colder temperatures correlated with physiologic changes to prey coloration.

4. The fishing lure of claim 3, wherein layers of thermochromic material between said base layer and said outer layer provide seasonal coloration correlated to seasonal water temperature by layering said thermochromic materials so that the appropriate seasonal coloration is associated with the appropriate temperature range by selecting the appropriate transition temperatures for each layer and applying each in a layer of decreasing transition temperature from said base layer to said outer layer.

5. The fishing lure of claim 1, wherein at least some thermochromic materials are applied to said lure as a thermochromic paint.

6. The fishing lure of claim 5, wherein at least some thermochromic materials are applied to said lure by at least one method selected from the group consisting physical vapor deposition, sputtering, sol-gel techniques, pulsed laser techniques, and chemical vapor deposition.

7. The fishing lure of claim 1, wherein said lure may be either a hard bait or a soft bait.

8. The fishing lure of claim 7, wherein a soft bait lure may be impregnated with thermochromic materials.

9. The fishing lure of claim 1, wherein non-thermochromic paint is applied to said lure to add detail necessary for all seasonal colorations to more accurately resemble said prey.

10. A fishing lure which mimics the seasonal coloration of prey for fish comprising:
a body resembling prey for fish;
a first seasonal color scheme associated with said prey applied to at least part of said body using at least one thermochromic material, said at least one thermochromic material having a transition temperature that approximately correlates with water temperatures in which said prey's color resembles said first seasonal color scheme so as to mask said base seasonal color scheme below said transition temperature and reveal said base seasonal color scheme at or above said transition temperature; and
a base layer having a base seasonal color scheme associated with said prey applied to at least part of said body using at least one thermochromic material having a desired color and transition temperature, said base seasonal color scheme being revealed when overlying layers of thermochromic materials have transition temperatures below that found in water temperatures in which said prey's color resembles said base seasonal color scheme.

11. The fishing lure of claim 10, further applying at least one thermochromic material having a desired color and transition temperature over at least some thermochromic materials associated with said first seasonal color scheme so as to mask at least part of said first seasonal color scheme below said transition temperature to reveal said first seasonal color scheme at or above said transition temperature when said thermochromic material is substantially transparent.

12. The fishing lure of claim 10, wherein at least some of said thermochromic materials undergo a reversible color change at their transition temperature.

13. The fishing lure of claim 10, wherein colors and transition temperatures for said plurality of thermochromic materials are chosen and layered so as to cause said lure to resemble prey for fish by applying said plurality of thermochromic materials so that a base layer on said lure body incorporates colorations that cause said lure to resemble said prey at warmer temperatures correlated with physiologic changes to prey coloration and an outer layer on said body incorporates colorations and features that cause said lure to resemble said prey at colder temperatures correlated with physiologic changes to prey coloration.

14. The fishing lure of claim 13, wherein layers of thermochromic material between said base layer and said outer layer provide seasonal coloration correlated to seasonal water temperature by layering said thermochromic materials so that the appropriate seasonal coloration is associated with the appropriate temperature range by selecting the appropriate transition temperatures for each layer and applying each in a layer of decreasing transition temperature from said base layer to said outer layer.

15. The fishing lure of claim 10, wherein at least some thermochromic materials are applied to said lure as a thermochromic paint.

16. The fishing lure of claim 15, wherein at least some thermochromic materials are applied to said lure by at least one method selected from the group consisting physical vapor deposition, sputtering, sol-gel techniques, pulsed laser techniques, and chemical vapor deposition.

17. The fishing lure of claim 10, wherein said lure may be either a hard bait or a soft bait.

18. The fishing lure of claim 17, wherein a soft bait lure may be impregnated with thermochromic materials.

19. The fishing lure of claim 10, wherein non-thermochromic paint is applied to said lure to add detail lines necessary for all seasonal colorations to more accurately resemble said prey.

20. The fishing lure of claim 10, wherein thermochromic paint is applied to said lure to add detail lines which can transition so as to cause the lure to resemble different species.

21. A fishing lure comprising:
a lure body that resembles prey for fish selected from the group consisting of crawfish and bluegill;
thermochromic paint applied to said lure body that imparts a reversible coloration change to said lure body which corresponds to a seasonal physiologic coloration change in said prey wherein said thermochromic paint incorporates thermochromic materials that are selected to impart an appropriate seasonal color to said lure body below a transition temperature and which becomes substantially transparent at or above a transition temperature, layered so as to impart a colder water coloration below all transition temperatures and to sequentially reveal lower layers as each upper layer becomes substantially transparent as a the water temperature rises and an upper layer transition temperature is met which reveals the coloration of said lower layer which possess a higher transition temperature than said top layer.

22. The fishing lure of claim 21, wherein said thermochromic materials selected match a desired seasonal coloration and have a transition temperature correlated to expected water temperatures during which time said seasonal physiologic coloration changes occur.

23. The fishing lure of claim 22, wherein a crawfish lure onto which thermochromic paint is applied is brown and orange in color below about 59° F. (15° C.), purple in color between about 59° F. (15° C.) and about 64° F. (18° C.) when said orange thermochromic paint transitions to transparent at about 59° F. (15° C.), and green in color at or above 64° F. (18° C.) when said purple thermochromic paint transitions to transparent at about at about 64° F. (18° C.).

24. The fishing lure of claim 23, wherein a bluegill lure onto which thermochromic paint is applied possesses a lower half that is a grayish-green below about 70° F. (21° C.) and transitions to orange and yellow patches above the transition temperature of about 70° F. (21° C.) for the grayish-green thermochromic paint.

25. The method of making a thermochromic fishing lure that resembles prey for fish that has seasonal color changes by layering a plurality of thermochromic materials onto a body in the order that transition temperatures decrease with each successive layer outward from said base layer so as to reveal the layer beneath each successive outerlayer as temperatures increase and transition temperatures are achieved.

26. The method of claim 25, wherein said thermochromic materials are layered so as to cause the lure to resemble the natural coloration of the prey for fish it resembles during the season in which it is used by selecting colors and transition temperatures that simulate the appearance of said prey for fish during each temperature range in which it is intended for use.

27. The method of claim 26, wherein desired colorations are achieved by causing an opaque thermochromic material upper layer to overlay a thermochromic material bottom layer so as to impart the hue of the bottom layer into said upper layer.
